(19) United States
(12) Patent Application Publication
(10) Pub. No.: US 2023/0196388 A1
(43) Pub. Date: Jun. 22, 2023

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Yusuke NAGATOMO, Shinagawa Tokyo (JP)

(21) Appl. No.: 17/959,767

(22) Filed: Oct. 4, 2022

(30) Foreign Application Priority Data
Dec. 21, 2021 (JP) 2021-207510

(51) Int. Cl. G06Q 30/02

(52) U.S. Cl. CPC G06Q 30/0201; G06Q 30/0283

(57) ABSTRACT

In accordance with an embodiment, an information processing apparatus receives a designation of a budget and a category of a product from a user. The information processing apparatus extracts, on the basis of data associating, for each of a plurality of products, a category to which the corresponding product belongs and a price of the product with each other, a product from products that belong to each of the received categories, the extracted product including a plurality of extracted products, a total amount of the extracted products fitting within the received budget.

### CROSS-REFERENCE TO RELATED APPLICATIONS

This application is based upon and claims the benefit of priority from the prior Japanese Patent Application No. 2021-207510, filed on Dec. 21, 2021, the entire contents of which are incorporated herein by reference.

### FIELD

An embodiment to be described here generally relates to an information processing apparatus and an information processing method.

### BACKGROUND

A sales method (EC: Electronic Commerce) that sells products via the Internet is actively used. Further, also in stores such as supermarkets, a sales method called an online supermarket in which products in a store are sold via the Internet is used. The online supermarket is operated such that when an order to purchase a product is received from a customer via the Internet, the ordered product is collected from the store and delivered to the customer's home.

Incidentally, in the above-mentioned online supermarket, a customer selects and orders a product from a terminal apparatus such as a personal computer via the Internet, but there is a problem that the operation of the terminal apparatus is complicated and burdensome for customers who are unfamiliar with the operation of the terminal apparatus. Further, since the customer searches for a product to be purchased from a large number of products displayed on the menu on the terminal apparatus, there is a problem that it takes time to select a product. There is still much room for further improvement in the existing technology that seeks to solve this problem.

### BRIEF DESCRIPTION OF THE DRAWINGS

FIG. 1 is a diagram showing the entire system according to an embodiment;

FIG. 2 is a diagram showing an example of a hardware configuration of an online supermarket server according to the embodiment;

FIG. 3 is a diagram showing an example of a data configuration of a product master according to the embodiment;

FIG. 4 is a diagram showing an example of a data configuration of an additional information file according to the embodiment;

FIG. 5 is a diagram showing an example of a data configuration of a customer master according to the embodiment;

FIG. 6 is a diagram showing an example of a data configuration a purchase history file according to the embodiment;

FIG. 7 is a diagram showing an example of a functional configuration of the online supermarket server according to the embodiment;

FIG. 8 is a diagram showing an example of a new registration screen according to the embodiment;

FIG. 9 is a diagram showing an example of a top screen according to the embodiment;

FIG. 10 is a diagram showing an example of a condition input screen according to the embodiment;

FIG. 11 is a diagram showing an example of an extraction result screen according to the embodiment;

FIG. 12 is a diagram showing an example of a checking screen according to the embodiment; and

FIG. 13 is a flowchart showing an example of processing executed by the online supermarket server according to the embodiment.

### DETAILED DESCRIPTION

In accordance with an embodiment, an information processing apparatus includes a communication device; a storage device; and a controller. The communication device performs communication with a customer terminal operated by a user. The storage device stores product master data. The product master data includes, for each of a plurality of products, information regarding a category to which the corresponding product belongs and information regarding a price of the product. The controller is configured to receive a designation of a budget and categories of products by a user's operation from the customer terminal via the communication device. The controller is further configured to extract, on the basis of the stored product master data, a product from products that belong to each of the received categories, the extracted product including a plurality of extracted products, a total amount of the extracted products fitting within the received budget. The controller is further configured to present information regarding the extracted products as information regarding candidate products to be purchased to the customer terminal via the communication device.

A server and an information processing method (program) according to an embodiment will be described below in detail with reference to the drawings. In the drawings, the same reference symbols indicate the same or similar parts. Note that the embodiment is not limited to the following description.

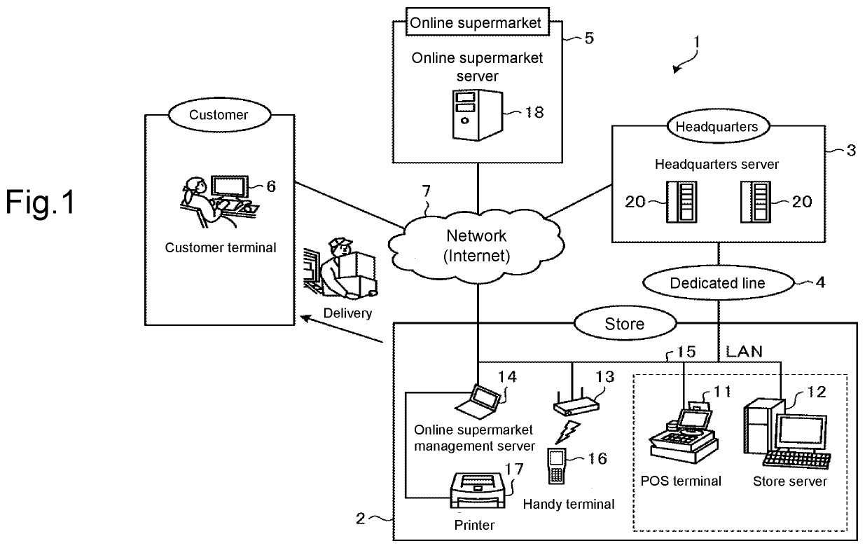

FIG. 1 is a diagram showing the entire system 1 according to this embodiment. In FIG. 1, a store system 2 and a headquarters system 3 are connected to each other by, for example, a dedicated line 4. Further, the store system 2 is connected, via a network 7, to an online supermarket system 5 that is a server. Further, the online supermarket system 5 is connected to a customer terminal 6 via the network 7.

The headquarters system 3 is, for example, a system provided in the headquarters that operate a store. The headquarters system 3 includes a headquarters server 20. The headquarters server 20 holds a product master (master data) for storing and managing product information of products sold in a store and a customer master (master data) for storing and managing customer information of a customer (user) using a store. Further, the headquarters server 20 stores a purchase history file for storing and managing a purchase history of the customer using a store. The product master, the customer master, and the purchase history file each have a data configuration similar to those of a product master 1805a, a customer master 1805c, and a purchase history file 1805d stored in the online supermarket system 5, which will be described below. The headquarters server 20 transmits product information of the product master and customer information of the customer master to a store server 12 of each store via the dedicated line 4.

Note that in this embodiment, the product master, the customer master, and the purchase history file stored in the headquarters server 20 each hold information relating to a product sold in a real store and a customer using a real store. Further, the product master 1805a, the customer master 1805c, and the purchase history file 1805d stored in the online supermarket system 5, which will be described below, each hold information relating to a product sold in an online supermarket and a customer using an online supermarket. However, the present disclosure is not limited thereto. Various types of data stored in both apparatuses may be integrated and the integrated data may be stored in one or both of the apparatuses.

The store system 2 is a system provided in a store. The store system 2 includes a point of sales (POS) terminal 11, the store server 12, an access point 13, an online supermarket management server 14, and the like. The respective apparatuses in the store system 2 are communicably connected to each other via a local area network (LAN) line 15.

The POS terminal 11 executes data processing of a product sold in a store. The store server 12 collects the data on which data processing has been performed by the POS terminal 11. Further, the store server 12 transmits information and a command from the headquarters server 20 to the POS terminal 11 and an online supermarket server 18.

The online supermarket management server 14 executes, on the basis of product-purchase information transmitted from the online supermarket server 18, data processing of picking a product purchased in the online supermarket and packing the product. The packing of a product is executed by inputting product information by a handy terminal 16 and the input product information is transmitted to the online supermarket management server 14 via the access point 13. The online supermarket management server 14 outputs, when the packing of a product is finished, data of a delivery slip to a printer 17, and the printer 17 prints the delivery slip.

The online supermarket system 5 is a system in charge of an online supermarket service. The online supermarket system 5 may be provided in, for example, a data center. Further, the online supermarket system 5 may be provided in the headquarters system 3 or in the store system 2.

The online supermarket system 5 includes the online supermarket server 18. The online supermarket server 18 has various types of functions and data relating to provision of an online supermarket service. The online supermarket server 18 may include one server apparatus or a plurality of server apparatuses. In the latter case, the online supermarket server 18 includes, for example, a web server that publishes an EC site for an online supermarket on the network 7, a database server that stores a customer database including a customer master, a product database including a product master, and the like, a delivery server that delivers emails to customers, and the like. Note that although an example in which the online supermarket server 18 includes one server apparatus is described in this embodiment for convenience of description, the present disclosure is not limited thereto.

The online supermarket server 18 is an example of an information processing apparatus. The online supermarket server 18 is communicably connected to the store system 2 of a store and the customer terminal 6 via the network 7. The online supermarket server 18 stores information regarding a customer, information regarding a product sold in an online supermarket, and the like. The online supermarket server 18 provides, when being accessed by the customer terminal 6, a Web screen to the customer terminal 6, a product sold in a store being purchasable on the Web screen. The online supermarket server 18 accepts an order operation relating to purchase of a product from the customer terminal 6. Further, the online supermarket server 18 transmits product-purchase information indicating a breakdown of the ordered product to the store system 2 (online supermarket management server 14) of a store.

The customer terminal 6 is a terminal apparatus operated by a user (customer) using a store or an online supermarket. The customer terminal 6 may include, for example, a stationary terminal apparatus such as a PC or a portable terminal apparatus such as a smartphone and a tablet terminal.

Specifically, the customer terminal 6 includes a control unit (not shown) of a computer configuration including a central processing unit (CPU), a read only memory (ROM), a random access memory (RAM), and the like. Further, the customer terminal 6 includes, in addition to a communication unit for connecting to the network 7, an operation unit such as a keyboard, a display unit, and a storage unit such as a hard disk drive device (which are not shown).

The control unit of the customer terminal 6 cooperates with a program stored in the storage unit to execute various types of processing and functions. For example, the control unit of the customer terminal 6 accesses the online supermarket server 18 in accordance with an operation of a customer via the operation unit and displays a purchase screen provided from the online supermarket server 18 on the display unit.

Next, a configuration of the above-mentioned online supermarket server 18 will be described.

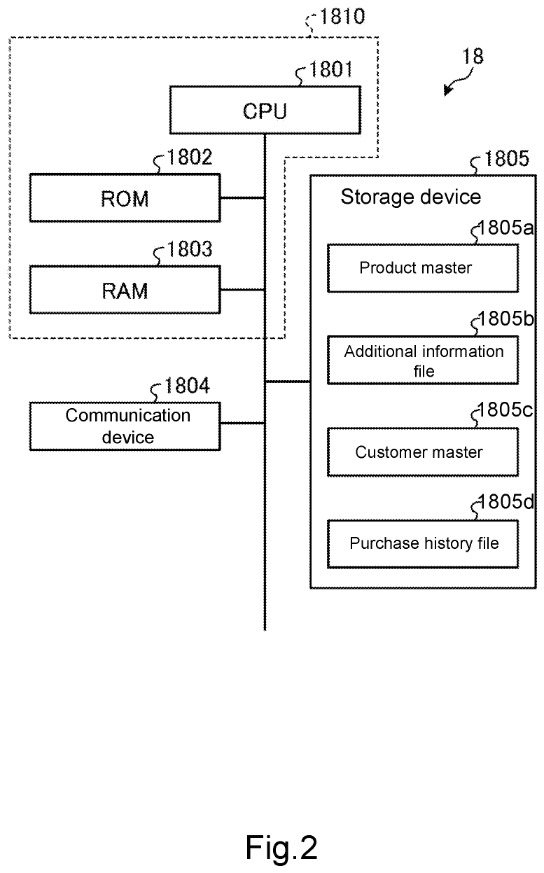

FIG. 2 is a diagram showing an example of a hardware configuration of the online supermarket server 18. As shown in FIG. 2, the online supermarket server 18 includes a CPU 1801, a ROM 1802, and a RAM 1803.

The CPU 1801 is an example of a processor and integrally controls the operation of the online supermarket server 18. The ROM 1802 stores various programs. The RAM 1803 is a workspace for developing a program and various types of data. The CPU 1801, the ROM 1802, and the RAM 1803 are connected to each other via a bus or the like, and constitute a controller 1810 having a computer configuration. In the controller 1810, the CPU 1801 operates in accordance with a program that is stored in the ROM 1802 and a storage device 1805 and is loaded into the RAM 1803, thereby executing various types of processing.

The controller 1810 is connected to a communication device 1804 and the storage device 1805 via a bus or the like. The communication device 1804 is a communication interface connectable to the network 7. The communication device 1804 communicates with an external apparatus such as the store system 2, the headquarters system 3, and the customer terminal 6 via the network 7.

The storage device 1805 includes a hard disk drive (HDD), a flash memory, or the like, and maintains the stored content even when the power source is cut off. The storage device 1805 stores various programs that can be executed by the CPU 1801. Further, the storage device 1805 stores, for example, the product master 1805a, an additional information file 1805b, the customer master 1805c, and the purchase history file 1805d.

The product master 1805a stores product information of a product sold in an online supermarket. Specifically, the product master 1805a stores, in association with an identifier capable of identifying each store (hereinafter, the store ID), product information of a product sold in an online supermarket by the store.

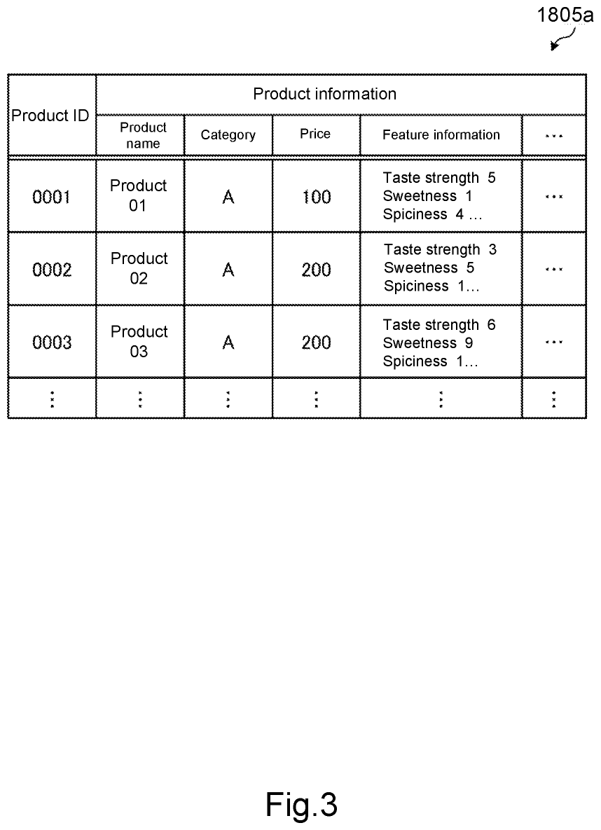

FIG. 3 is a diagram showing an example of a data configuration of the product master 1805a. As shown in FIG. 3, the product master 1805a stores a product ID of each product to be sold and product information in association with each other. The product ID is an identifier capable of identifying a product, and a product code such as a JAN code can be used as the product ID. The product information includes a product name, a category, a price, a product image, feature information, and the like of a product corresponding to the product ID. The feature information is information indicating the features of a product corresponding to the product ID. For example, in the case where the product is a foodstuff, the feature information may be one quantitatively representing various features of the foodstuff such as the taste strength, the spiciness, and the sweetness by an index value that can be compared with another foodstuff. For example, in FIG. 3, various features such as the taste strength, the spiciness, and the sweetness are represented by index values on a scale of one to ten.

The additional information file 1805b stores additional information relating to a product sold in an online supermarket. In this embodiment, the additional information file 1805b stores, as additional information, information that can be used for supporting the order of a product. As an example, the additional information file 1805b stores information indicating the sales ranking of a product. In this case, the additional information may be one aggregated by the headquarters server 20 on the basis of the sales results of a product purchased in each store or may be one aggregated by the controller 1810 on the basis of the sales results of a product purchased in an online supermarket.

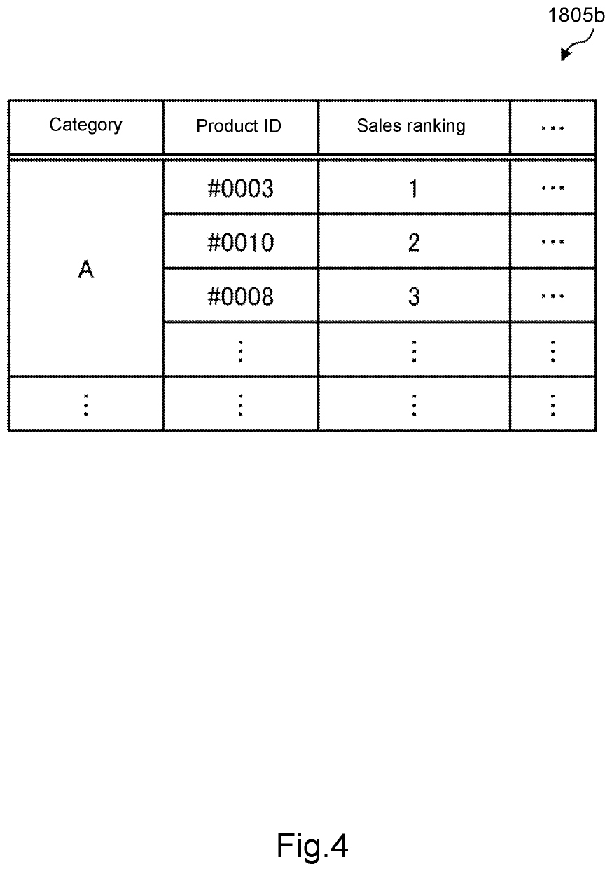

FIG. 4 is a diagram showing an example of a data configuration of the additional information file 1805b. As shown in FIG. 4, the additional information file 1805b stores, for each of categories of products, the product ID of a product that belongs to the corresponding category and the sales ranking of the product in association with each other. Note that FIG. 4 shows a case where information regarding a product is disposed in order from the top of the sales ranking.

Note that information stored in the additional information file 1805b is not limited to the example shown in FIG. 4. For example, the additional information file 1805b may store, for each of categories of products, information indicating the arrival order of a product that belongs to the corresponding category. Further, the additional information file 1805b may store, for each of categories of products, the product ID of a product to be promoted (hereinafter, referred to also as a recommended product), of products that belong to the corresponding category. Further, the additional information file 1805b may be prepared for each type of additional information.

The customer master 1805c stores information relating to a customer using an online supermarket. Specifically, the customer master 1805c stores, in association with a customer ID capable of identifying each customer, customer information of the customer corresponding to the customer ID.

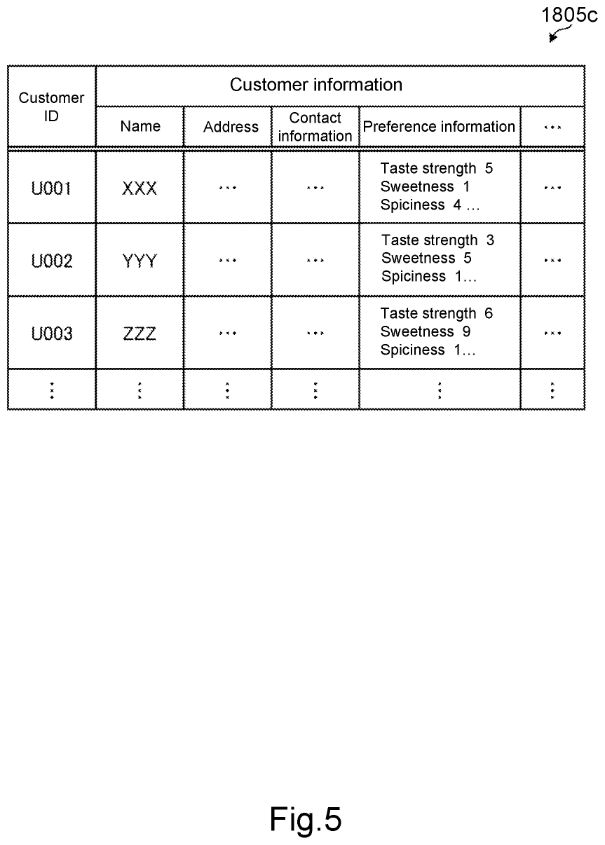

FIG. 5 is a diagram showing an example of a data configuration of the customer master 1805c. As shown in FIG. 5, the customer master 1805c stores customer information in association with a customer ID. The customer ID is an example of an identifier capable of identifying each customer. As the customer ID, for example, a unique ID assigned to each customer, an e-mail address, or a telephone number can be used. The customer information includes preference information in addition to basic information such as the name, address, and contact information (e.g., telephone number or e-mail address) of a customer.

The preference information includes information indicating a preference of a customer. For example, the preference information includes, as a preference relating to taste, a value quantitatively representing a preference relating to the taste strength, the spiciness, and the sweetness (hereinafter, referred to also as a preference value). Note that the preference information may be input together at the time of registration of basic information or may be automatically extracted on the basis of history information described below. Further, the customer information (basic information) may include a password set at the time of, for example, registration of the customer ID.

The purchase history file 1805d stores history information of a product purchased by a customer using an online supermarket. Specifically, the purchase history file 1805d stores, in association with a customer ID, history information of the customer corresponding to the customer ID.

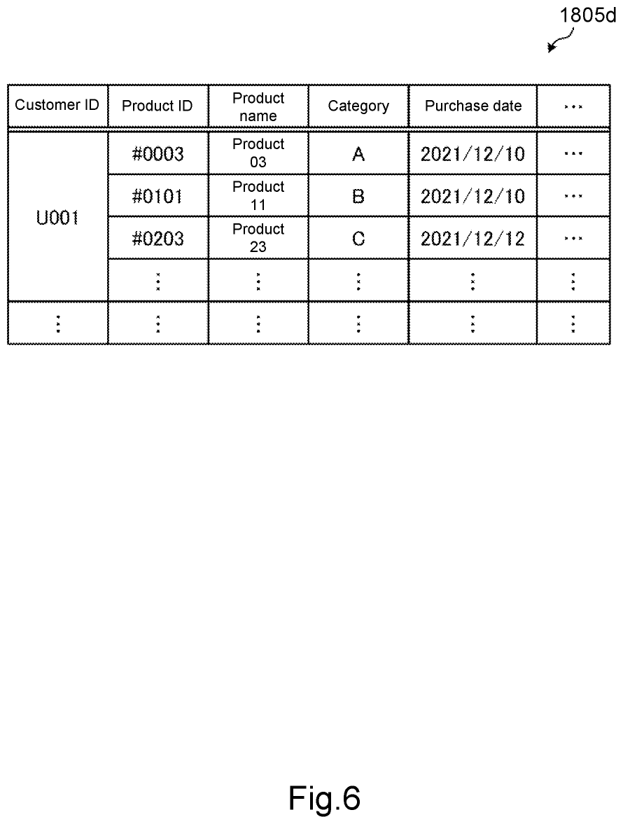

FIG. 6 is a diagram showing an example of a data configuration of the purchase history file 1805d. As shown in FIG. 6, the purchase history file 1805d stores history information in association with a customer ID. The history information includes, for example, a purchase date in addition to the product ID, the product name, and the category of a purchased product. The purchase date is information indicating the date and time when the product was purchased.

Note that the history information stored in the purchase history file 1805d may include not only a purchase history of products purchased in an online supermarket but also a purchase history of products purchased in a store. In this case, the history information of products purchased in a store may be acquired from the headquarters server 20 or may be directly acquired from each store. Further, the history information may include retailer information indicating a retailer. In this case, for example, the history information of products purchased in a store includes information (store ID or the like) indicating the retailer.

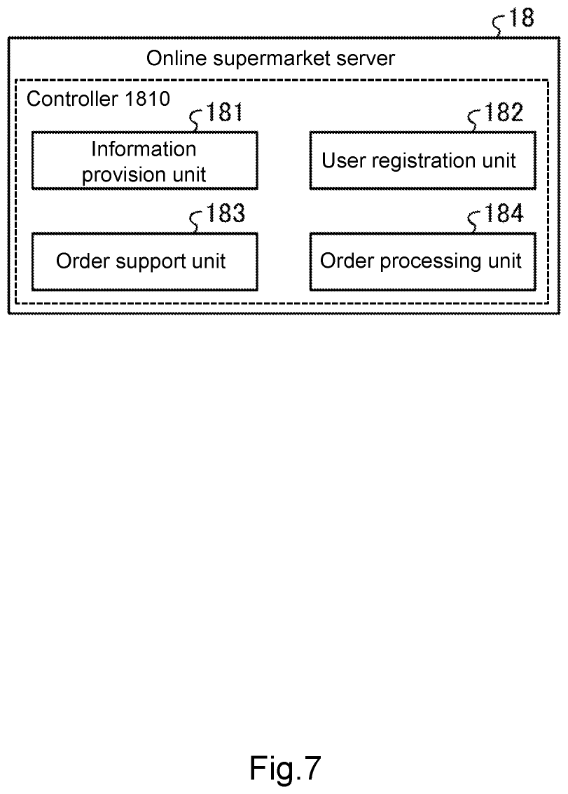

In the configuration of the above-mentioned online supermarket server 18, the controller 1810 cooperates with various programs, thereby realizing functional units for executing various types of processing. FIG. 7 is a diagram showing an example of a functional configuration of the online supermarket server 18.

As shown in FIG. 7, the controller 1810 of the online supermarket server 18 executes various programs stored in the storage device 1805 or the like, thereby realizing an information provision unit 181, a user registration unit 182, an order support unit 183, and an order processing unit 184.

The order support unit 183 is an example of a reception means and an extraction means, and the information provision unit 181 is an example of a presentation means. As an example of a reception means, the order support unit 183 receives a designation of a budget and a category of a product from a user. Further, as an example of an extraction means, the order support unit 183 extracts (selects), on the basis of data associating, for each of a plurality of products, a category to which the corresponding product belongs and a price of the product with each other, a product from products that belong to each of the received categories, the total amount of the extracted products fitting within the budget received by the information provision unit 181. Further, as an example of a presentation means, the information provision unit 181 presents the extracted products as candidate products to be purchased.

The information provision unit 181 provides various types of information relating to usage of an online supermarket to the customer terminal 6 that has accessed the online supermarket server 18. The information provided by the information provision unit 181 includes content or the like generated on the basis of the product master 1805a or the like, in addition to various operation screens (GUI) including the above-mentioned purchase screen.

The user registration unit 182 cooperates with the information provision unit 181 to execute processing of registering, in the customer master 1805c, customer information of a customer using an online supermarket. Specifically, on the basis of an operation screen provided by the information provision unit 181 to the customer terminal 6, the user registration unit 182 registers customer information input to the operation screen in the customer master 1805c.

The order support unit 183 cooperates with the information provision unit 181 to execute processing for supporting the order of a product in an online supermarket. Specifically, the order support unit 183 extracts, from products registered in the product master 1805a, a product that is a candidate for purchase (hereinafter, referred to also as a candidate product) and presents information regarding the extracted candidate product to a customer via the customer terminal 6.

More specifically, when a customer designates a category and a budget, the order support unit 183 extracts a candidate product that can be purchased within the budget from the designated category. As the method of extracting a candidate product, various methods can be adopted.

For example, the order support unit 183 may preferentially extract, on the basis of preference information included in the customer information of the corresponding customer stored in the customer master 1805c, a product that matches the preference of the customer from the designated category. Further, the order support unit 183 may preferentially extract, on the basis of the purchase history of the corresponding customer stored in the purchase history file 1805d, a product that has been purchased in the past from the designated category. Further, the order support unit 183 may preferentially extract, on the basis of the additional information file 1805b, a product with a high sales ranking (popular product) or a recommended product from the designated category. Note that although the number of candidate products extracted from each category is one in this embodiment, a plurality of candidate products may be extracted.

The order support unit 183 extracts a candidate product using the above-mentioned extraction method, but the extraction method to be used is not particularly limited. For example, the order support unit 183 may use one extraction method set in advance to extract a candidate product. Further, the order support unit 183 may use an extraction method designated by a customer to extract a candidate product. Further, the order support unit 183 may use a plurality of extraction methods in combination to extract a candidate product. Further, the method of extracting a candidate product is not limited to the examples described above.

Further, the number of categories that can be designated at one time is not limited to one and may be two or more. In the case where a plurality of categories has been designated, the order support unit 183 allocates the budget on the basis of the number of categories or the like, and extracts, for each category, a candidate product within the allocated budget. For example, in the case where a budget “3000 yen” and three categories “A”, “B”, and “C” have been designated, the order support unit 183 (proportionally) divides the budget into three equal parts in accordance with the number of categories and extracts a candidate product from each category within the budget of 1000 yen. Note that the method of allocating the budget is not limited to this example. For example, the order support unit 183 may determine, on the basis of the average price of products that belong to each category, the ratio of the budget to be allocated for each category. Further, the order support unit 183 calculate, for each category, the average price of the purchased products or the like by analyzing the purchase history of the corresponding customer and determine, on the basis of the calculation result, the ratio of the budget to be allocated for each category.

Note that there is a possibility that when the extraction method described above is used, substantially similar products are presented every time. For example, in the case where a customer purchases the same product every time and in the case of a popular product, there is a possibility that the same product is presented every time.

In this regard, the order support unit 183 has a function for presenting an alternative product (hereinafter, a similar product) of a candidate product extracted by the above-mentioned extraction method instead of or together with the candidate product.

Specifically, the order support unit 183 extracts, from products that belong to the designated category, a product within the budget other than a candidate product extracted from the category, as a similar product. The method of extracting a similar product is not particularly limited, and various method can be adopted.

For example, the order support unit 183 may randomly extract a similar product satisfying the condition described above. Further, the order support unit 183 may extract, on the basis of the sales ranking and the recommended product stored in the additional information file 1805b, a similar product satisfying the condition described above. Further, the order support unit 183 may extract, on the basis of the purchase history of the corresponding customer stored in the purchase history file 1805d, a similar product satisfying the condition described above. Note that although the number of similar products to be extracted from each category is one in this embodiment, a plurality of similar products may be extracted.

The order processing unit 184 executes, on a product to be purchased, processing relating to the order of the product (hereinafter, referred to also as order processing). Specifically, when an operation of confirming a product to be purchased is performed by a customer operating the customer terminal 6, the order processing unit 184 associates the product ID and the product information of the target product with the purchase quantity, and transmits, as product-purchase information, the obtained information to the online supermarket management server 14 together with customer information of the customer.

Further, when the order processing is completed, the order processing unit 184 stores, on the basis of the product-purchase information, the purchase history of the customer who has placed the order in the purchase history file 1805d. Specifically, the order processing unit 184 stores, in association with the customer ID of the customer who has placed the order, the product ID, the product name, the price, the purchase quantity, and the like of the product ordered by the customer in the purchase history file 1805d.

Note that although the store of the online supermarket server 18 that is the transmission destination is not particularly limited, it is favorable to select a store near the address of a customer. For example, the order processing unit 184 may select, on the basis of the address included in the customer information of the corresponding customer, a store located within a predetermined range from the address. Further, for example, the order processing unit 184 may select, on the basis of the history information of the corresponding customer stored in the headquarters server 20, a store frequently used by the customer.

Further, in the case where payment of a product is performed in the online supermarket server 18, the order processing unit 184 may perform payment processing of a product to be purchased. In this case, the payment method is not particularly limited, and a known method such as credit payment and electronic payment can be used.

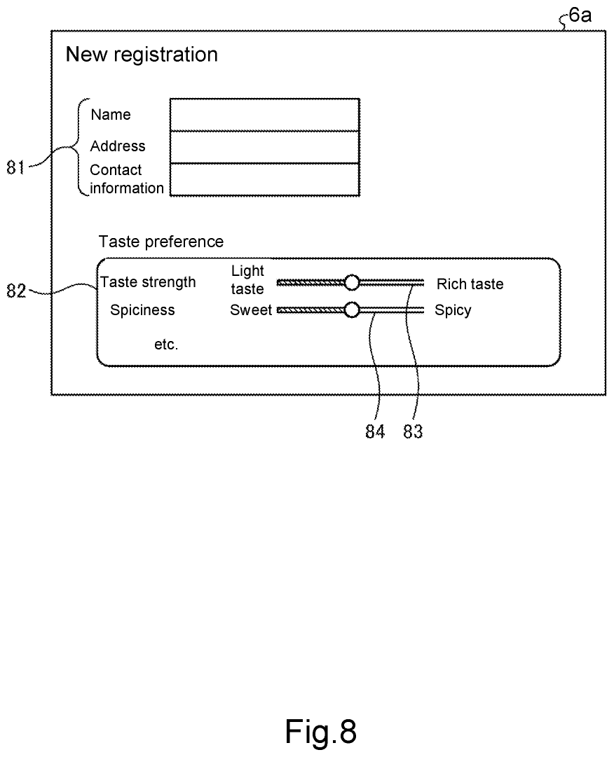

An operation of the controller that functions as the information provision unit 181, the user registration unit 182, the order support unit 183, and the order processing unit 184 will be described with reference to FIG. 8 to FIG. 10.

For example, the information provision unit 181 provides, to the customer terminal 6, information regarding a new registration screen relating to usage of an online supermarket for a customer using an online supermarket for the first time, and displays the new registration screen on the display unit of the customer terminal 6.

FIG. 8 is a diagram showing an example of a new registration screen 6a. As shown in FIG. 8, the new registration screen 6a includes an input field 82 for inputting preference information in addition to an input field 81 for inputting basic information (name, address, contact information, and the like) of a customer.

FIG. 8 shows an example of the input field 82 for inputting, as a taste preference, preferences of the taste strength, the spiciness, and the sweetness. In this input field 82, preference values for the taste strength, the spiciness, and the sweetness are input using volume sliders 83 and 84. A customer can input a preference value relating to taste by operating the volume sliders 83 and 84. Note that the content to be input as preference information is not limited to the example shown in FIG. 8, and preference information other than taste may be input.

When basic information and preference information are input to the new registration screen 6a and an instruction to register has been received, the user registration unit 182 registers the input basic information and preference information in the customer master 1805c as customer information of a new customer.

Note that the customer ID may be explicitly input by a customer or may be automatically assigned by the user registration unit 182. Further, in the case where a customer ID has been assigned to the same customer by member registration or the like in a store, it is favorable to register the same customer ID as the customer ID used in the store. As a result, since the purchase history of products purchased in the store and the purchase history of products purchased in an online supermarket by the same customer can be managed in association with each other, it is possible to efficiently manage data.

Further, the information provision unit 181 provides information regarding a top screen (top page) corresponding to the entrance of an online supermarket to the customer terminal 6 and displays the top screen on the display unit of the customer terminal 6.

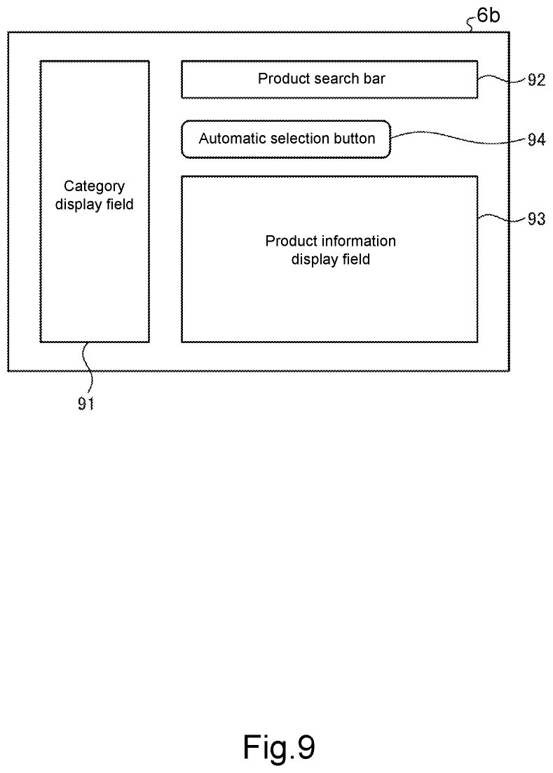

FIG. 9 is a diagram showing an example of a top screen 6b. As shown in FIG. 9, the top screen 6b includes a category display field 91, a product search bar 92, a product information display field 93, and an automatic selection button 94. Further, the top screen 6b may include an operator (e.g., a new registration button) for instructing to display the above-mentioned new registration screen 6a. Further, the top screen 6b may include a login form or the like for inputting a customer ID (and a password) of a customer. Note that in the following description, a customer has logged in by inputting the customer ID registered in the customer master 1805c.

A category of a product sold in an online supermarket is displayed in the category display field 91. For example, the information provision unit 181 displays, in the category display field 91, a list of categories registered in the product master 1805a. Further, when a specific category has been selected, the information provision unit 181 displays, in the category display field 91, a list of products that belong to the selected category. Further, when a specific product has been selected, the information provision unit 181 reads product information of the selected product from the product master 1805a and displays the read product information in the product information display field 93.

A search condition for searching for a product is input to the product search bar 92. As the search condition, for example, part or all of a product code and a product name can be used. When a search condition is input to the product search bar 92, the information provision unit 181 searches the product master 1805a for a product corresponding to the input search condition. The information provision unit 181 then displays the product information of the searched product in the product information display field 93.

The product information display field 93 is a region for displaying product information. For example, the information provision unit 181 displays, in the product information display field 93, product information of a product narrowed down by operating the category display field 91 or the product search bar 92. Note that the number of pieces of the product information displayed in the product information display field 93 is not limited to one and may be two or more. Further, the information displayed in the product information display field 93 is not limited to product information. For example, an operator or the like for making a product corresponding to the displayed product information a candidate to be purchased may be displayed in the product information display field 93.

The automatic selection button 94 is an operator for instructing to automatically select a candidate product. The information provision unit 181 provides, when accepting an operation of the automatic selection button 94, information regarding a condition input screen for inputting conditions of a budget and a category to the customer terminal 6 and displays the condition input screen on the display unit of the customer terminal 6.

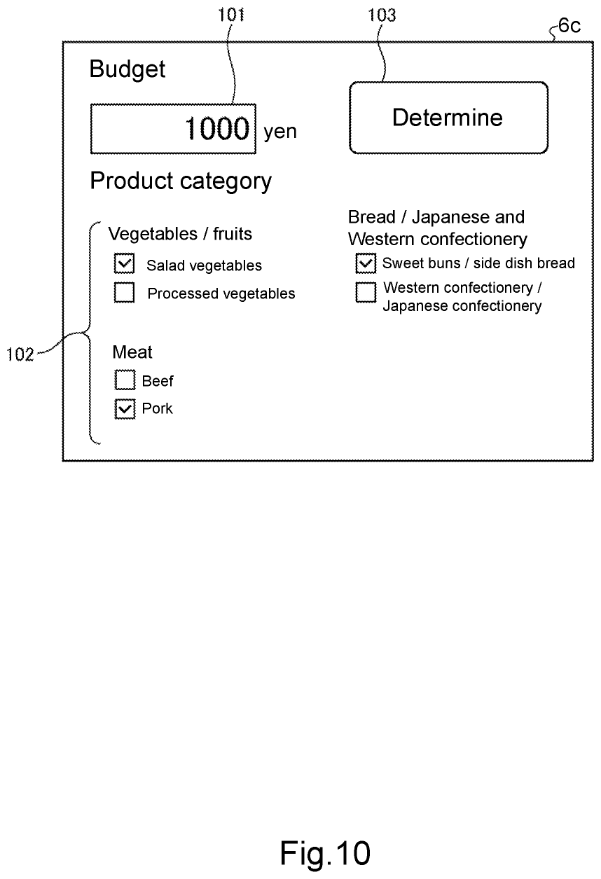

FIG. 10 is a diagram showing an example of a condition input screen 6c. As shown in FIG. 10, the condition input screen 6c includes a budget input field 101, a category selection field 102, and a determination button 103.

The budget input field 101 is a field for inputting the budget amount. A customer operating the customer terminal 6 inputs a desired budget in the budget input field 101. FIG. 10 shows an example in which “1000 yen” has been input as a budget.

Options capable of selecting a category of a product to be purchased are provided in the category selection field 102. A customer operating the customer terminal 6 puts a check mark to a desired category of the options provided in the category selection field 102 to select a category of a product to be purchased. FIG. 10 shows a case where three categories of “salad vegetables”, “sweet buns/side dish bread”, and “pork” are input as categories.

The determination button 103 is an operator for instructing to automatically extract a candidate product satisfying the conditions input in the budget input field 101 and the category selection field 102. When accepting an operation of the determination button 103, the order support unit 183 executes processing of extracting a candidate product on the basis of the conditions input in the budget input field 101 and the category selection field 102. For example, in the case of the example shown in FIG. 10, the order support unit 183 extracts a candidate product one by one from each of the categories of “salad vegetables”, “sweet buns/side dish bread”, and “pork” such that the total amount is less than the budget “1000 yen”. Further, the order support unit 183 may extract a similar product for one or all of the extracted candidate products.

When the order support unit 183 extracts a candidate product, the information provision unit 181 provides information regarding an extraction result screen indicating the extraction results to the customer terminal 6 and displays the extraction result screen on the display unit of the customer terminal 6.

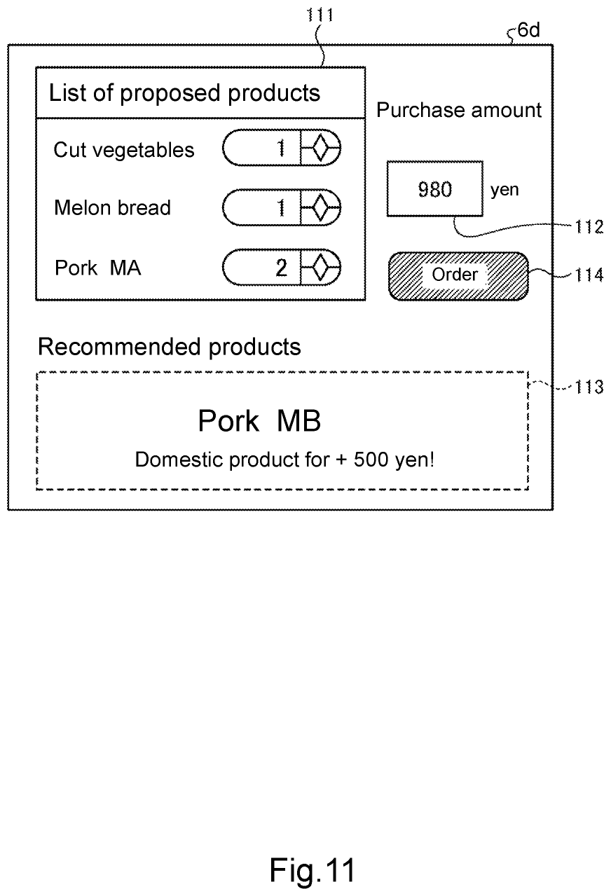

FIG. 11 is a diagram showing an example of an extraction result screen 6d. As shown in FIG. 11, the extraction result screen 6d includes a candidate product display field 111, a total amount display field 112, a similar product display field 113, and an order button 114.

The candidate product display field 111 is a region for displaying information regarding a candidate product extracted by the order support unit 183. Specifically, the information provision unit 181 reads a product name from product information corresponding to a candidate product extracted by the order support unit 183 and displays the read product name in the candidate product display field 111.

FIG. 11 shows an example in which “cut vegetables”, “melon bread”, and “pork MA” are displayed as candidate products. The “cut vegetables” is a candidate product extracted from products that belong to the category “salad vegetables”. The “melon bread” is a candidate product extracted from products that belong to the category “sweet buns/side dish bread”. The “pork MA” is a candidate product extracted from products that belong to the category “pork”.

Further, in the candidate product display field 111 shown in FIG. 11, the number of purchases of a candidate product is displayed in association with the product name of the candidate product. The number of purchases can be increased or decreased by an operation of a customer. That is, a customer operating the customer terminal 6 can designate the number of purchases of a candidate product. Note that the initial value of the number of purchases is “1”, and the order support unit 183 extracts a candidate product such that the total amount of each of the prices of one candidate product extracted from the respective categories fits within the designated budget.

Note that although a product name of a candidate product is displayed in the candidate product display field 111 in FIG. 11, the present disclosure is not limited thereto. For example, other information such as a price and a category of a candidate product may be displayed in the candidate product display field 111. Further, the information provision unit 181 may display an operator for deleting (erasing) a candidate product in the candidate product display field 111 of the extraction result screen 6d. In this case, the operator is displayed in association with each candidate product. When the operator is operated, the information provision unit 181 deletes the candidate product that is a target of the operation from the candidate product display field 111.

Further, the information provision unit 181 may display an operator for displaying a similar product in the candidate product display field 111. In this case, the operator is displayed in association with each candidate product. When the operator is operated, the candidate product display field 111 may extract a similar product from the category that is a target of the operation. The extracted similar product may be displayed in the candidate product display field 111 or the similar product display field 113.

The total amount display field 112 is a region for displaying the total amount of the candidate products displayed in the candidate product display field 111. The information provision unit 181 calculates, on the basis of the prices of the candidate products displayed in the candidate product display field 111, the total amount of the candidate products, and displays the calculated total amount in the total amount display field 112. Specifically, the information provision unit 181 calculates the total amount by summing the values obtained by multiplying the price of each candidate product by the number of purchases.

FIG. 11 shows an example in which “980 yen” is displayed in the total amount display field 112. Note that the information provision unit 181 may display the budget amount designated on the condition input screen 6c (see FIG. 10) in a form that can be compared with the total amount in the total amount display field 112. By displaying the budget and the total amount relating to the prices of the candidate products so as to be compared with each other, a customer can easily check the difference between the budget and the total amount, thereby making it possible to improve the convenience.

The similar product display field 113 is a region for displaying a similar product extracted by the order support unit 183. Specifically, the information provision unit 181 reads a product name and the like from the product information corresponding to the similar product extracted by the order support unit 183 and displays the product name and the like in the similar product display field 113.

FIG. 11 shows an example in which “pork MB” is displayed as a similar product of the category “pork” in the similar product display field 113. Further, an example in which information indicating that the “pork MB” is a domestic product and is 500 yen more expensive than the price of the “pork MA” is displayed as a difference from the candidate product “pork MA” in the same category is shown.

A customer operating the customer terminal 6 performs, in the case where, for example, he/she desires to purchase a similar product displayed in the similar product display field 113, an operation of selecting the similar product. The information provision unit 181 displays, when accepting an operation of selecting the similar product, the selected similar product in the candidate product display field 111 to add the selected similar product to the candidate products to be purchased. Note that when adding a similar product to the candidate product display field 111, the information provision unit 181 may delete, from the candidate product display field 111, a candidate product in the same category as that of the similar product displayed in the candidate product display field 111 or may leave the candidate product as it is.

The order button 114 is an operator for instructing to purchase the products (candidate products, similar products) displayed in the candidate product display field 111. The information provision unit 181 provides, when accepting an operation of the order button 114, information regarding a checking screen for checking the order content to the customer terminal 6 and displays the checking screen on the display unit of the customer terminal 6.

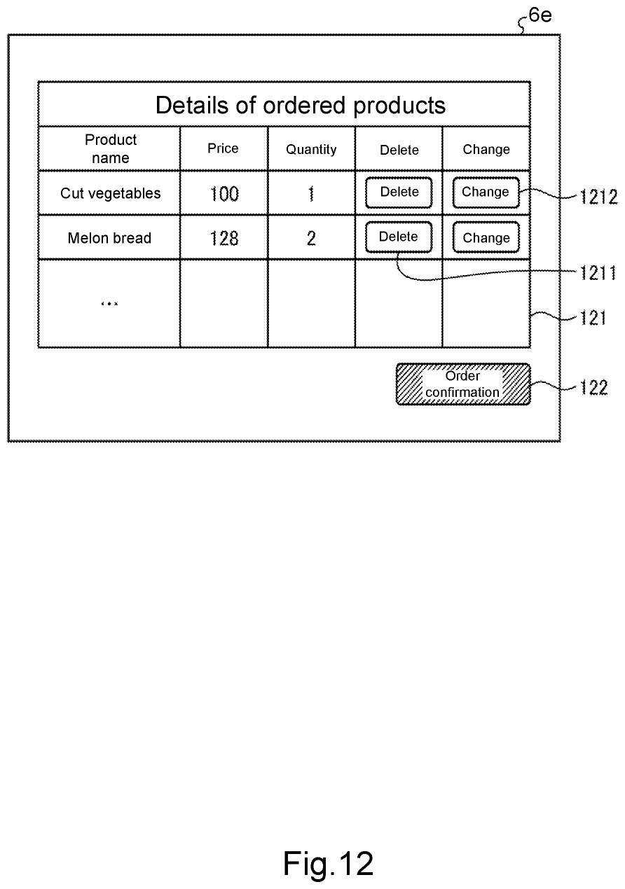

FIG. 12 is a diagram showing an example of a checking screen 6e. As shown in FIG. 12, the checking screen 6e includes an order content checking field 121 and an order confirmation button 122.

The products that have been displayed in the candidate product display field 111 when the order button 114 was operated on the extraction result screen 6d (see FIG. 11) are displayed in the order content checking field 121. Specifically, the information provision unit 181 displays, for each of the products that have been displayed in the candidate product display field 111, the product name, the price, and the purchase quantity of the corresponding product in the order content checking field 121. Further, a delete button 1211 and a change button 1212 are displayed in association with each product in the order content checking field 121.

The delete button 1211 is an operator for instructing to delete the corresponding product. The information provision unit 181 deletes, when accepting an operation of the delete button 1211, the information regarding the product corresponding to the operated delete button 1211 to exclude the product from a purchase list.

Further, the change button 1212 is an operator for instructing to change the corresponding product. When accepting an operation of the change button 1212, the information provision unit 181 cooperates with the order support unit 183 to provide information regarding an operation screen (not shown) for changing the product corresponding to the operated change button 1212 to another product (hereinafter, referred to also as a change screen) to the customer terminal 6 and display the change screen on the display unit of the customer terminal 6.

The change screen may be, for example, a screen capable of selecting a product to be purchased from similar products in the same category as that of the product corresponding to the target change button 1212, of the similar products extracted by the order support unit 183. Further, the change screen may be, for example, a screen capable of selecting a product to be purchased from a list of products that belong to the same category as that of the product corresponding to the target change button 1212. The information provision unit 181 displays, when a product is changed, the product name and the like of a product after the change in the checking screen 6e.

The order confirmation button 122 is an operator for instructing to confirm the purchase of products. Specifically, the order confirmation button 122 is an operator for instructing to confirm the products displayed in the order content checking field 121 as purchase targets, i.e., as products to be ordered in an online supermarket.

When accepting an operation of the order confirmation button 122, the order processing unit 184 associates, for each product displayed in the order content checking field 121, the product ID, the product information, and the purchase quantity with each other, and transmits, to the online supermarket management server 14, these pieces of information together with the name, address, contact information, and the like included in the customer information of the logged-in customer as product-purchase information.

As a result, a customer operating the customer terminal 6 can order a product on the basis of the products extracted by the order support unit 183. Therefore, in accordance with the online supermarket system 5 according to this embodiment, it is possible to reduce the burden of product selection on a customer and support the order of a product.

Note that the product to be ordered is not limited to the product extracted by the order support unit 183. For example, a product selected as a purchase target from the category display field 91 or the product information display field 93 of the top screen 6b (see FIG. 9), or the like may be included in a product to be ordered.

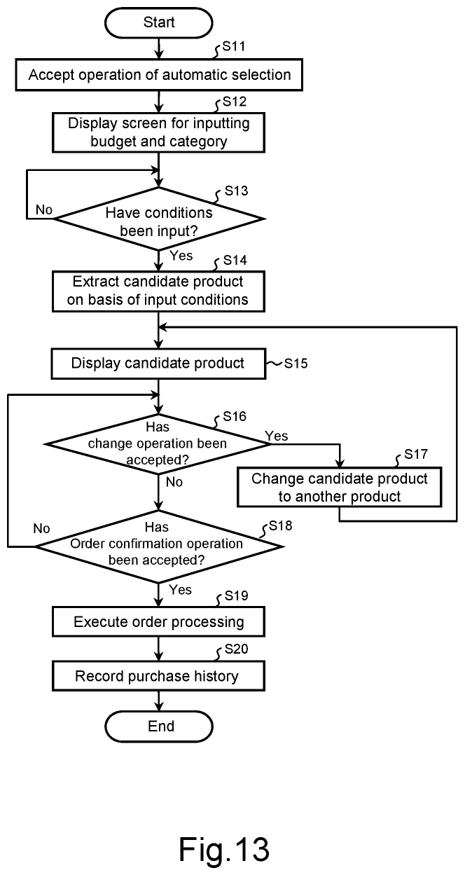

Next, an example of processing executed by the online supermarket server 18 will be described with reference to FIG. 13. FIG. 13 is a flowchart showing an example of processing executed by the online supermarket server 18.

Note that as a premise of this processing, customer information of a customer using an online supermarket has been registered in the customer master 1805c. Further, the online supermarket server 18 has provided information regarding the top screen 6b to the customer terminal 6, the top screen 6b has been displayed, and a customer operating the customer terminal 6 has logged in.

First, in Step S11 in FIG. 13, the information provision unit 181 of the controller 1810 accepts an operation of the automatic selection button 94 (see FIG. 9) in the top screen 6b of the customer terminal 6. In Step S12, the information provision unit 181 of the controller 1810 then provides information regarding a screen for inputting a budget and a category (e.g., the condition input screen 6c) to the customer terminal 6 to display the condition input screen 6c on the display unit of the customer terminal 6.

Subsequently, in Step S13, the order support unit 183 of the controller 1810 determines whether or not determination of conditions of a budget and a category has been instructed via the determination button 103 or the like in the condition input screen 6c of the customer terminal 6. The order support unit 183 of the controller 1810 then stands by until it is determined that determination of conditions of a budget and a category has been instructed (Step S13; No). In the case where it is determined that determination of conditions of a budget and a category has been instructed (StepS13; Yes), the processing of the controller 1810 proceeds to Step S14. In Step S14, the order support unit 183 of the controller 1810 receives the designated (input) conditions of a budget and a category (reception means) and extracts a candidate product from the product master 1805a on the basis of the conditions (extraction means).

Subsequently, in Step S15, the information provision unit 181 of the controller 1810 provides information regarding a screen displaying a product name and the like of a candidate product (e.g., the extraction result screen 6d, the checking screen 6e) to the customer terminal 6 to display the screen 6d or 6e on the display unit of the customer terminal 6 (presentation means).

subsequently, in Step S16, the information provision unit 181 of the controller 1810 determines whether or not a change operation of instructing to change a candidate product has been performed. In the case where it is determined that a change operation has been performed (Step S16; Yes), the processing of the controller 1810 proceeds to Step S17. In Step S17, the information provision unit 181 of the controller 1810 changes a candidate product to another product in accordance with an operation of a customer. After the candidate product is changed to another product, the processing of the controller 1810 returns to Step S15. Note that in Step S16, the information provision unit 181 of the controller 1810 determines, also in the case where deletion of a candidate product has been instructed, that a change operation of instructing to change a candidate product has been performed. In this case, the information provision unit 181 of the controller 1810 deletes, in Step S17, the display of the instructed candidate product in the checking screen 6e. After deleting the display of the candidate product, the processing of the controller 1810 returns to Step S15.

Note that when performing the processing of Step S17, the information provision unit 181 of the controller 1810 provides, to the customer terminal 6, a screen capable of selecting a product that is a change target such as a similar product extracted by the order support unit 183.

Meanwhile, in the case where it is determined in Step S16 that a change operation has not been performed (Step S16; No), the processing of the controller 1810 proceeds to Step S18. In Step S18, the information provision unit 181 of the controller 1810 determines whether or not an order confirmation operation of instructing to confirm an order has been performed. In the case where it is determined that an order confirmation operation has not been performed (Step S18; No), the processing of the controller 1810 returns to Step S16.

Further, in the case where it is determined that an order confirmation operation has been performed (Step S18; Yes), the processing of the controller 1810 proceeds to Step S19. In Step S19, the order processing unit 184 of the controller 1810 executes order processing. Specifically, the order processing unit 184 of the controller 1810 generates product-purchase information on the basis of the product ID, the purchase quantity, and the like of a candidate product as well as customer information of the logged-in customer. The order processing unit 184 then transmits the generated product-purchase information to the online supermarket management server 14.

In Step S20, the order processing unit 184 of the controller 1810 stores (records), in the purchase history file 1805d, a purchase history in which information regarding the time at which order processing was executed, the customer ID of the logged-in customer, the product ID of each product ordered this time, the purchase quantity, and the like are associated with each other (Step S20), and ends the processing shown in FIG. 13.

As described above, the online supermarket server 18 according to this embodiment is capable of reducing the burden of product selection on a customer and supporting the order of a product. That is, in accordance with this embodiment, a customer does not have to select products to be purchased one by one, and it is possible to extract, in accordance with a designated budget and category, an appropriate candidate product from products based on a preference and a purchase history of the customer or popular products or products to be promoted in a store and present the extracted product to the customer.

Note that the above-mentioned embodiment can be appropriately modified and implemented by changing part of the configuration or function of each apparatus described above. In this regard, some modifications according to the above-mentioned embodiment will be described below as another embodiment. Note that in the following, differences from the above-mentioned embodiment will be mainly described. Specifically, points common to the content that has been described are denoted by the same reference symbols and detailed description thereof is omitted. Further, modifications described below may be individually implemented or may be appropriately combined and implemented.

### Modification

In the above-mentioned embodiment, the online supermarket server 18 automatically extracts, when a budget and a category is designated in the customer terminal 6, a product (candidate product) on the basis of the designated conditions and presents the extracted product to the customer operating the customer terminal 6. However, it is unnecessary to apply automatic extraction of a product to all the designated categories and automatic extraction of a product may be applied to only some of the categories.

For example, for a specific category, there is a customer who orders the same product every time. In such a case, it is favorable to present the product that he/she orders every time without performing automatic extraction of a product for the specific category, from a viewpoint of processing load. In order to realize such a form, for example, the online supermarket server 18 can have the following configuration.

First, the online supermarket server 18 stores, in the storage device 1805 or the like, a standard product list in which the product ID of a product that a customer purchases every time and the category to which the product indicated by the product ID belongs are associated with the customer ID of the customer. For example, the standard product list may be incorporated and held in the customer master 1805c (see FIG. 2).

Note that the standard product list is prepared for each customer, and the method of generating and managing the standard product list is not particularly limited. For example, an operator (check button or the like) capable of setting a product to a standard product may be provided on the above-mentioned operation screen in association with the respective products in various categories displayed on the operation screen, and the product may be added or deleted to/from the standard product list in accordance with an operation of the operator. In this case, the information provision unit 181 of the controller 1810 may generate and manage the standard product list or another functional unit may generate and manage the standard product list.

Further, the order support unit 183 of the controller 1810 checks, in the case where a budget and a category has been designated as conditions relating to automatic extraction of a product from a customer operating the customer terminal 6, whether or not a product in the designated category is registered in the standard product list corresponding to the customer ID of the customer. In the case where a product in the designated category is registered in the standard product list, the order support unit 183 refrains from performing automatic extraction of a candidate product for the corresponding category and preferentially extracts, as a candidate product, a product in the corresponding category registered in the standard product list.

Note that the order support unit 183 of the controller 1810 performs automatic extraction of a candidate product in the remaining designated category on the basis of the amount of money obtained by subtracting the price of the product extracted from the standard product list from the budget.

As a result, in the online supermarket server 18 according to this modification, it is possible to inhibit the automatic extraction function of a candidate product for the category set in advance by a customer and preferentially present a standard product typically purchased by the customer. Therefore, a customer operating the customer terminal 6 can check the automatically extracted product by designating a budget and a category and order a product that he/she purchases every time, thereby making it possible to improve the convenience.

Note that the program executed in each apparatus according to the above-mentioned embodiment (and the modification) is incorporated in a ROM, a storage device, or the like and provided. The program executed in each apparatus according to the above-mentioned embodiment may be recorded in a computer-readable recording medium such as a CD-ROM, a flexible disk (FD), a CD-R, and a digital versatile disk (DVD) in an installable format file or an executable format file and provided.

Further, the program executed in each apparatus according to the above-mentioned embodiment may be stored in a computer connected to a network such as the Internet, downloaded via the network, and provided. Further, the program executed in each apparatus according to the above-mentioned embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a communication device that performs communication with a customer terminal operated by a user;
a storage device that stores product master data, the product master data including, for each of a plurality of products, information regarding a category to which the corresponding product belongs and information regarding a price of the product; and
a controller configured to
receive a designation of a budget and categories of products by a user's operation from the customer terminal via the communication device,
extract, on a basis of the stored product master data, a product from products that belong to each of the received categories, the extracted product including a plurality of extracted products, a total amount of the extracted products fitting within the received budget, and
present information regarding the extracted products as information regarding candidate products to be purchased to the customer terminal via the communication device.

2. The information processing apparatus according to claim 1, wherein
the controller is further configured to present information regarding an operation screen for receiving a designation of a budget and categories of products by a user's operation to the customer terminal via the communication device.

3. The information processing apparatus according to claim 1, wherein
the controller is further configured to extract, on a basis of preference information indicating a preference of the user for the product, a product satisfying a condition of the preference information from products that belong to each of the received categories, the extracted product including a plurality of extracted products, a total amount of the extracted products fitting within the received budget.

4. The information processing apparatus according to claim 3, wherein
the storage device further stores customer master data, the customer master data including, for each user, preference information of the corresponding user, and
the controller is further configured to extract, on a basis of the customer master data stored in the storage device, a product satisfying a condition of the preference information from products that belong to each of the received categories, the extracted product including a plurality of extracted products, a total amount of the extracted products fitting within the received budget.

5. The information processing apparatus according to claim 4, wherein
the product master data stored in the storage device further includes, for each of a plurality of products, feature information of the corresponding product, and
the controller is further configured to extract, on a basis of the feature information of the product included in the product master data, a product satisfying a condition of the preference information from products that belong to each of the received categories.

6. The information processing apparatus according to claim 1, wherein
the controller is further configured to extract, on a basis of a purchase history recording products purchased by the user in a past, a product recorded by the purchase history from products that belong to each of the received categories, the extracted product including a plurality of extracted products, a total amount of the extracted products fitting within the received budget.

7. The information processing apparatus according to claim 6, wherein
the storage device further stores a purchase history file, the purchase history file including information regarding a product purchased by the user in a past, and
the controller is further configured to extract, on a basis of the purchase history file stored in the storage device, a product recorded by the purchase history from products that belong to each of the received categories, the extracted product including a plurality of extracted products, a total amount of the extracted products fitting within the received budget.

8. The information processing apparatus according to claim 1, wherein
the controller is further configured to
receive an instruction to change one of the candidate products by a user's operation from the customer terminal via the communication device,
extract, in accordance with the instruction to change one of the candidate products, a product that belongs to the same category as that of the one candidate product and is different from the one candidate product as a similar product, and
present the similar product to the customer terminal via the communication device instead of the one candidate product on which the instruction to change has been made.

9. The information processing apparatus according to claim 8, wherein
the controller is further configured to
extract a product that belongs to the same category as that of the one candidate product and is different from the one candidate product as a similar product, and
presents information regarding an operation screen for allowing to receive an operation of making the similar product one of the candidate products to the customer terminal via the communication device.

10. An information processing method for an information processing apparatus, comprising:
storing, in a storage device, product master data, the product master data including, for each of a plurality of products, information regarding a category to which the corresponding product belongs and information regarding a price of the product;
receiving, by using a communication device to perform communication with a customer terminal operated by a user, a designation of a budget and categories of products by a user's operation from the customer terminal;
extracting, on a basis of the stored product master data, a product from products that belong to each of the received categories, the extracted product including a plurality of extracted products, a total amount of the extracted products fitting within the received budget; and
presenting information regarding the extracted products as information regarding candidate products to be purchased to the customer terminal via the communication device.
